(19) United States
(12) Patent Application Publication
(10) Pub. No.: US 2020/0408658 A1
(43) Pub. Date: Dec. 31, 2020

(54) SAMPLE PROPERTY IDENTIFICATION DEVICE, SAMPLE PROPERTY IDENTIFYING METHOD, AND SAMPLE TRANSPORT SYSTEM

(71) Applicant: Hitachi, Ltd., Tokyo (JP)

(72) Inventor: Kiyoshi Nasu, Hitachi-shi (JP)

(73) Assignee: Hitachi, Ltd., Tokyo (JP)

(21) Appl. No.: 16/814,165

(22) Filed: Mar. 10, 2020

(30) Foreign Application Priority Data
Jun. 26, 2019 (JP) 2019-118300

(51) Int. Cl. G01N 15/05; G01N 21/31; G06K 9/62

(52) U.S. Cl. CPC G01N 15/05; G06K 9/6202; G01N 21/314

(57) ABSTRACT

A sample imaging condition is made appropriate in a sample property identification device. A container containing a sample is placed between a backlight and a camera, and a first image is acquired by imaging the container. A brightness of the backlight is set based on a sample image included in the first image, and a second image is acquired by imaging the container. Based on a sample image included in the second image, a hemolysis level and a chyle level are identified as a property of the sample.

### CROSS REFERENCE TO RELATED APPLICATION

This application claims priority to Japanese Patent Application No. 2019-118300 filed on Jun. 26, 2019, which is incorporated herein by reference in its entirety including the specification, claims, drawings, and abstract.

### TECHNICAL FIELD

The present disclosure relates to a sample property identification device, a method of identifying a sample property, and a sample transport system, and in particular to a technique for identifying a property of a sample based on an image acquired by imaging a sample.

### BACKGROUND

A sample property identification device is a device, for example, which identifies a property of a sample or whether or not the sample is an abnormal sample. More specifically, when the sample is blood serum, a hemolysis level, a chyle level, or the like is identified by the sample property identification device. Hemolysis is a state which is caused by destruction of red blood cells or the like in a sample container and in which the blood serum has turned reddish. Chyle is a state which is caused by the blood serum containing neutral fats, and in which the blood serum has turned yellowish. When the hemolysis level or the chyle level is high, the blood serum cannot be appropriately analyzed. Thus, prior to the analysis of the blood serum, it is desired to specify these levels. The sample property identification device is generally incorporated in a sample preprocessor apparatus, a sample analysis apparatus (a biochemical analysis device, an immunoassay device, or the like), or a sample transport device. In some cases, with the sample property identification device, properties of a sample other than blood serum, for example, blood plasma or urine, are identified.

JP 2004-37322 A discloses an apparatus in which a sample is observed by a sensor with a backlight as a background. This apparatus measures an amount of sample. JP 2013-72806 A discloses an apparatus in which the hemolysis level is determined based on a color phase of an image acquired by imaging a sample, and the chyle level is determined based on a lightness of the image. In order to specify the lightness of the image, a shutter speed of a camera is changed stepwise.

In order to identify the property of the sample with high precision, an operation condition of a light source used in the imaging of the sample must be appropriately set. For example, in an image acquired by imaging a sample having a high hemolysis level or a high chyle level, a brightness of the sample image is low. If the brightness of the light source at the time of imaging of the sample is too low, the brightness of the sample image comes close to a noise level, and the sample image cannot be correctly evaluated. On the other hand, in an image acquired by imaging a sample having a low hemolysis level or a low chyle level, the brightness of the sample image would be high. If the brightness of the light source at the time of imaging of the sample is too high, the brightness of the sample image is saturated, and the sample image cannot be correctly evaluated. In order to correctly identify the property of the sample, it is desired to change the brightness of the light source according to a color depth or a transmittance of light in the sample. More generally, it is desired to change an operation condition of the light source according to the property of the sample.

An advantage of the present disclosure lies in allowing setting of an appropriate imaging condition according to a property of a sample. Alternatively, an advantage of the present disclosure lies in improvement of identification precision of the property of the sample.

### SUMMARY

According to one aspect of the present disclosure, there is provided a sample property identification device comprising: a light source that is provided at one side of an imaging position at which a container containing a sample is placed; a camera that is provided at the other side of the imaging position, that images the container to acquire a first image during a first imaging, and that images the container to acquire a second image during a second imaging subsequent to the first imaging; a controller that sets, prior to the second imaging, an operation condition of the light source in the second imaging, based on a sample image included in the first image; and an identifier that identifies a property of the sample based on a sample image included in the second image.

According to another aspect of the present disclosure, there is provided a method of identifying a property of a sample, the method comprising: executing, in a state where a container containing a sample is placed between a light source and a camera, a first imaging on the container to acquire a first image; setting a brightness of the light source in a second imaging subsequent to the first imaging, based on a sample image included in the first image; executing, after the setting of the brightness, the second imaging on the container to acquire a second image; and identifying a property of the sample based on a sample image included in the second image.

According to another aspect of the present disclosure, there is provided a sample transport system comprising: a transport device that transports a container containing a sample from a receiving section to an analyzing section; and a sample identification device that is provided between the receiving section and the analyzing section, wherein the sample identification device comprises: a light source which is provided at one side of an imaging position at which the container is placed; a camera which is provided at the other side of the imaging position, which images the container to acquire a first image during a first imaging, and which images the container to acquire a second image during a second imaging subsequent to the first imaging; a controller which sets, prior to the second imaging, an operation condition of the light source in the second imaging based on a sample image included in the first image; and an identifier which identifies whether or not the sample is an abnormal sample based on a sample image included in the second image, and, when the sample is the abnormal sample, the transport device does not transport the container containing the sample to the analyzing section, and instead transports the container to an abnormal sample retrieval unit.

According to the present disclosure, an appropriate imaging condition can be set according to the property of the sample. Alternatively, according to the present disclosure, identification precision of the property of the sample can be improved.

### BRIEF DESCRIPTION OF DRAWINGS

Embodiment(s) of the present disclosure will be described based on the following figures, wherein:

FIG. 1 is a block diagram showing a blood analysis system according to an embodiment of the present disclosure;

FIG. 2 is a conceptual diagram showing a first example of a sample property identification device;

FIG. 3 is a diagram showing an example structure of a light source evaluator;

FIG. 4 is a diagram for explaining an imaging condition;

FIG. 5 is a diagram for explaining a method of inspecting a light source;

FIG. 6 is a diagram showing an example structure of a property identifier;

FIG. 7 is a diagram showing a relationship between a property of a sample and a light source brightness;

FIG. 8 is a diagram for explaining a method of determining a container type;

FIG. 9 is a diagram showing an imaging area which is set for a container;

FIG. 10 is a diagram showing an example of an image including a container image;

FIG. 11 is a diagram for explaining a method of analyzing an image;

FIG. 12 is a diagram for explaining a method of simultaneously identifying three properties;

FIG. 13 is a diagram for explaining a method of identifying fibrin;

FIG. 14 is a flowchart showing an operation during light source inspection;

FIG. 15 is a flowchart showing a property identification operation;

FIG. 16 is a flowchart showing an alternative configuration of a property identification operation;

FIG. 17 is a block diagram showing a second example of a sample property identification device;

FIG. 18 is a diagram showing a manipulator in a second example;

FIG. 19 is a diagram showing a container which is set at a horizontal orientation;

FIG. 20 is a diagram showing an example of an image processing; and

FIG. 21 is a diagram showing another example of an image processing.

### DESCRIPTION OF EMBODIMENTS

An embodiment of the present disclosure will now be described with reference to the drawings.

### (1) Summary of Embodiment

According to an embodiment of the present disclosure, the sample property identification device comprises a light source, a camera, a controller, and an identifier. The light source is provided at one side of an imaging position at which a container containing a sample is placed. The camera is provided at the other side of the imaging position, images the container to acquire a first image during a first imaging, and images the container to acquire a second image during a second imaging subsequent to the first imaging. The controller sets, prior to the second imaging, an operation condition of the light source in the second imaging, based on a sample image included in the first image. The identifier identifies a property of the sample based on a sample image included in the second image.

According to the structure described above, the operation condition of the light source in the second imaging can be set based on the sample image included in the first image which is acquired earlier; that is, based on a form of the sample itself, which is the identification target. Thus, it becomes possible to set the imaging condition during the second imaging to a condition suited for the form of the sample. For example, the brightness of the light source is adjusted based on a color depth or a light transmittance amount of the sample which is the identification target. With this configuration, it becomes possible to avoid or reduce problems caused by the brightness of the light source being too high or too low. Alternatively, conditions other than the brightness, for example, a color temperature of the light source, may be controlled.

The imaging position normally is fixedly defined, but alternatively, the imaging position may be dynamically defined. By providing the imaging position and a measurement unit including the light source and the camera within a darkroom or a semi-darkroom, adverse influences due to external light can be prevented or reduced. The one side and the other side of the imaging position are in an opposing relationship with the imaging position therebetween. In the embodiment, the container is transported between a rack and the imaging position. Alternatively, the container may be imaged in a state where the container is housed on the rack. In this case, a location of housing the container is the imaging position.

Alternatively, a configuration may be employed in which the second imaging is executed only when it is judged, based on the first image acquired by the first imaging, that the operation condition of the light source during the first imaging is not appropriate. That is, when it is judged that the operation condition of the light source during the first imaging is appropriate, the second imaging is not executed. In this case, the identifier identifies the property of the sample based on the first image. Alternatively, a configuration may be employed in which the second imaging is always executed.

According to an embodiment of the present disclosure, the controller sets a brightness of the light source in the second imaging, based on a brightness of the sample image included in the first image. The brightness of the sample image is an average brightness, a representative brightness, or the like. According to an embodiment of the present disclosure, the controller sets a brightness of the light source in the first imaging to a first brightness. The controller sets a second brightness which is lower than the first brightness as the brightness of the light source in the second imaging when the brightness of the sample image included in the first image is determined to be too high, or sets a second brightness which is higher than the first brightness as the brightness of the light source in the second imaging when the brightness of the sample image included in the first image is determined to be too low. Alternatively, the first brightness may be selected by the user or automatically. For example, the first brightness may be set to a low brightness or to a high brightness according to an objective of property identification, an expected ratio of the number of abnormal samples, or the like. The controller may skip the second imaging when the brightness of the sample image is judged as appropriate.

According to an embodiment of the present disclosure, the controller sets a low brightness as the brightness of the light source in the second imaging when the brightness of the sample image included in the first image is determined to be too high, and sets a high brightness, which is higher than the low brightness, as the brightness of the light source in the second imaging when the brightness of the sample image included in the first image is determined to be too low. Alternatively, a medium brightness may be set as the brightness of the light source during the first imaging.

According to an embodiment of the present disclosure, the sample is blood serum or blood plasma, and the identifier identifies a hemolysis level and a chyle level based on the sample image included in the second image. For example, the hemolysis level is determined based on a degree of reddishness of the sample image and the chyle level is determined based on a degree of whitishness of the sample image. According to an embodiment of the present disclosure, the identifier changes a hemolysis level determination condition and a chyle level determination condition based on a type of the container containing the sample. A color of the container affects the color and the color depth of the sample image. A size of the container, in particular, a thickness of the container, affects the color depth of the sample image at each position in a horizontal direction. In consideration of these factors, the determination conditions are changed based on the type of the container.

According to an embodiment of the present disclosure, the identifier specifies a group of effective pixels in the sample image included in the second image, and identifies the property of the sample based on the group of effective pixels. According to an embodiment of the present disclosure, the identifier specifies pixels in the sample image other than one or a plurality of ineffective pixels as the group of effective pixels. In this case, the one or the plurality of ineffective pixels include, for example, at least one of a pixel corresponding to a rib provided on the container or a pixel corresponding to a streak caused during a molding process of the container. According to this configuration, the influence of the container can be reduced, and the precision of the property identification can be improved.

According to an embodiment of the present disclosure, the identifier specifies a color of the container containing the sample based on at least one of the first image and the second image, and changes a condition for identifying the property of the sample based on the color of the container. Color itself of the container, which is beyond the type of the container, is specified, and the property of the sample is identified in consideration of the color. The concept of the color of the container includes a color phase, a color depth, or the like. According to this configuration, it becomes possible to accurately identify the property of the sample.

According to an embodiment of the present disclosure, the controller evaluates the light source based on an image acquired by imaging the light source under a situation where no container exists at the imaging position. According to this configuration, for example, degradation of the light source can be specified, and can be compensated for. When there is an operation deficiency in the light source, the deficiency can be specified.

According to an embodiment of the present disclosure, a normal light source and an ultraviolet light source are provided as the light source. The identifier includes an image processor which generates a fibrin image based on an image acquired by imaging the container using the normal light source and an image acquired by imaging the container using the ultraviolet light source. According to experiments, a phenomenon is observed in which, when ultraviolet ray is irradiated onto the sample, the fibrin, a separating agent, and the like in the sample glow. It is desirable to apply an image processing to suppress elements other than the fibrin and to emphasize the fibrin. The normal light source generates visible light serving as white light, and the ultraviolet light source generates an ultraviolet ray.

According to an embodiment of the present disclosure, the light source is a flat plate-shaped backlight in which the normal light source and the ultraviolet light source are integrated. According to this configuration, a light source installation space can be reduced. In addition, placement of the light source and the camera in an opposing relationship with the container therebetween can be facilitated.

According to an embodiment of the present disclosure, a method of identifying a property of a sample comprises a first imaging step, a brightness setting step, a second imaging step, and a property identifying step. In the first imaging step, in a state where a container containing a sample is placed between a light source and a camera, a first imaging is executed on the container to acquire a first image. In the brightness setting step, a brightness of the light source in a second imaging subsequent to the first imaging is set based on a sample image included in the first image. In the second imaging step, after the setting of the brightness, the second imaging is executed on the container to acquire a second image. In the property identifying step, a property of the sample is identified based on a sample image included in the second image. Alternatively, a configuration may be employed in which appropriateness of the brightness of the light source during the first imaging; that is, necessity of the second imaging, may be judged based on the sample image included in the first image.

According to an embodiment of the present disclosure, a sample transport system comprises a transport device and a sample identification device. The transport device transports a container containing a sample from a receiving section to an analyzing section. The receiving section is a section which receives the container, and corresponds to a leading portion of a transport line. The sample identification device is provided between the receiving section and the analyzing section. The sample identification device has a light source, a camera, a controller, and an identifier. The light source is provided at one side of an imaging position at which the container is placed. The camera is provided at the other side of the imaging position, images the container to acquire a first image during a first imaging, and images the container to acquire a second image during a second imaging subsequent to the first imaging. The controller sets, prior to the second imaging, an operation condition of the light source in the second imaging, based on a sample image included in the first image. The identifier identifies whether or not the sample is an abnormal sample based on a sample image included in the second image. When the sample is the abnormal sample, the transport device does not transport the container containing the sample to the analyzing section and instead transports the container to an abnormal sample retrieval unit.

According to the configuration described above, it become possible to prevent sending of a sample which does not need to be analyzed to the analyzing section. Thus, a transporting efficiency of an analyzing efficiency can be improved, and wasteful consumption of reagents can be avoided.

### (2) Details of Embodiment

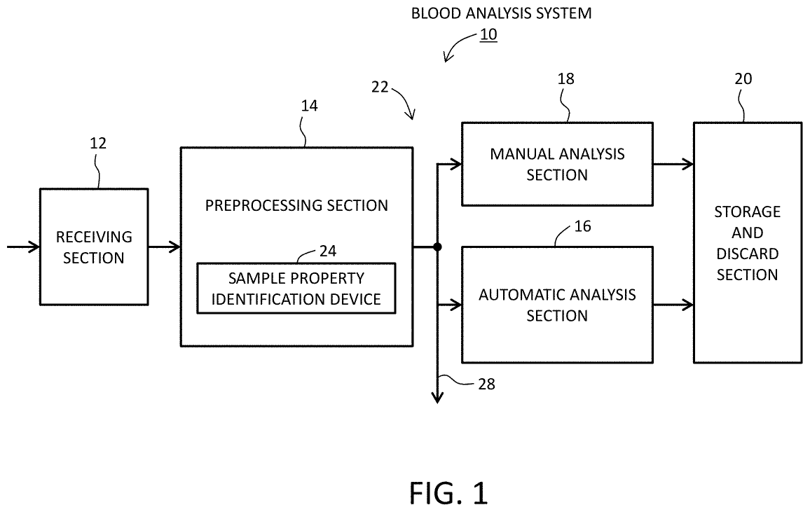

FIG. 1 shows an example structure of a blood analysis system according to an embodiment of the present disclosure. A blood analysis system 10 illustrated in FIG. 1 is a system provided in a blood analysis center or the like, and comprises a receiving section 12, a preprocessing section 14, an automatic analysis section 16, a manual analysis section 18, a storage and discard section 20, and the like. A mechanism which transports a rack between these sections is a sample transporting apparatus 22. A plurality of containers are held on the rack, each container containing a sample. In the present embodiment, the sample is blood serum. Other examples of the sample include blood plasma, whole blood, and the like. Further, blood after centrifugation, urine gathered from a living body, or the like may serve as the sample.

A plurality of samples sent from a hospital or the like are introduced into the receiving section 12 in units of racks. In the receiving section 12, for each sample, sample identification information is read. For example, a label having a barcode is adhered to the container containing the sample, and the barcode is optically read. Alternatively, an RFID tag is provided on the container containing the sample, and information is electromagnetically read from the RFID tag. The rack is transported from the receiving section 12 to the preprocessing section 14.

The preprocessing section 14 applies a preprocess to individual samples as necessary. The preprocessing section 14 has a centrifugation unit, a plug-opening unit, a dispensing unit, or the like. In the present embodiment, the preprocessing section 14 further has a sample property identification device 24. The centrifugation unit applies a centrifugation process on the sample. The plug-opening unit is a unit which removes a plug provided on the container containing the sample or which creates a situation where dispensing through the plug is enabled. The dispensing unit is a unit which suctions the sample and distributes and dispenses the suctioned sample to a plurality of containers, to produce a plurality of child samples from one parent sample. Each child sample is also transported in units of racks.

The sample property identification device 24 is placed, in the preprocessing section 14, at a location where identification of a sample property is necessary. For example, the sample property identification device 24 is provided at an uppermost stream position, an intermediate position, or a lowermost stream position in the preprocessing section 14. Alternatively, the sample property identification device 24 may be provided as a part of the sample transport device 22. Alternatively, the sample property identification device 24 may be incorporated in each analysis device in the automatic analysis section 16. Alternatively, a child sample may be set as an identification target in the sample property identification device 24.

In the present embodiment, the sample property identification device 24 is a device which identifies a hemolysis level and a chyle level in the sample. Information indicating the identified hemolysis level and the identified chyle level is sent to an upper-level system which controls the blood analysis system 10. For example, samples having a high hemolysis level or a high chyle level are handled as abnormal samples. The sample property identification device 24 may alternatively be considered as an abnormal sample identification device. In the present embodiment, in the sample property identification device 24, the samples are classified based on a color tone of the sample. Thus, the sample property identification device 24 may also be considered as a sample color tone classification device.

In the example structure illustrated in FIG. 1, the abnormal sample is not transported to the automatic analysis section 16 and the manual analysis section 18, but instead is sent to an abnormal sample retrieval unit (refer to reference numeral 28). A specific structure of the sample property identification device 24 will be described later in detail. Alternatively, a sample amount measurement device to be described later may be provided in the preprocessing section 14 and the sample transport device 22.

The automatic analysis section 16 is a section which analyzes each sample, and one or a plurality of analysis devices are provided in the automatic analysis section 16. The analysis device is, for example, a biochemical analysis device, an immunoassay device, or the like. The manual analysis section 18 is a section which conducts manual analysis. The storage and discard section 20 is a section which stores or discards a sample for which the analysis is completed. In FIG. 1, a large-scale system is shown, but alternatively, the sample property identification device 24 may be incorporated in a device which is used as a single entity or in a small-scale system.

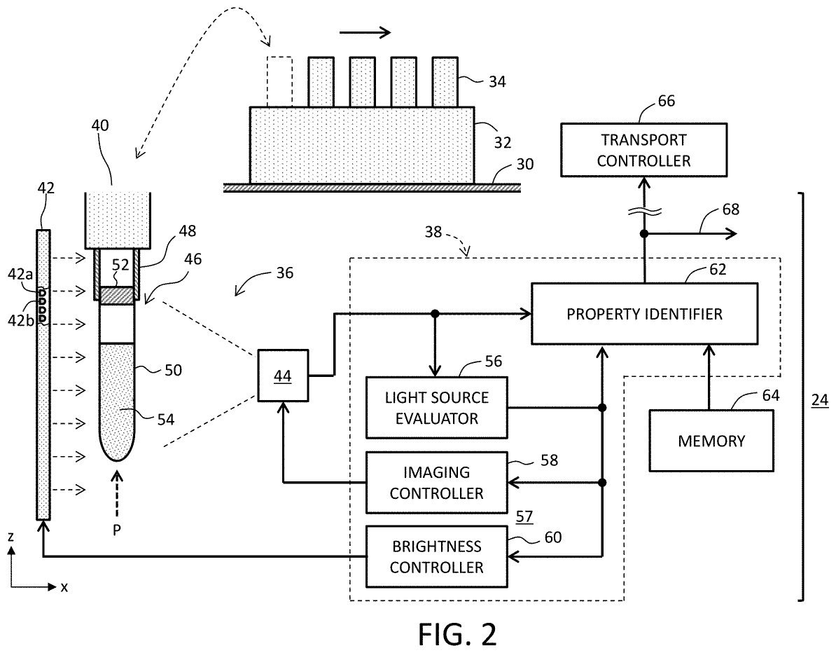

FIG. 2 schematically shows a partial structure of the sample transport device and an overall structure of the sample property identification device. A rack 32 is transported by the sample transport device. Specifically, the rack 32 is transported, for example, by a belt conveyor 30. The rack 32 holds a plurality of containers 34. Each container 34 contains blood serum as the sample. The container 34 is a transparent tube, and is, for example, a test tube. Alternatively, the container 34 may be a blood collecting tube.

The sample property identification device 24 illustrated in the figures has a measurement unit 36 and a calculating and controlling unit 38. The measurement unit 36 includes a transport mechanism 40, a backlight 42, and a camera 44. The measurement unit 36 is contained in a housing (not shown). An inside of the housing is a darkroom or a space close to a darkroom. In the measurement unit 36, an imaging position P is defined at which a container 46 is positioned during imaging. The transport mechanism 40 is formed from a manipulator which transports the container 46 in an arbitrary three-dimensional direction, which has a plurality of fingers 48 for clamping the container 46.

The container 46 is formed from a container body 50 and a plug 52 sealing an upper opening of the container body 50. A sample 54 is contained in the container body 50. The container body 50 is formed from a material having transparency. A thickness and a color of the container differ depending on a container type. In FIG. 2, the container 46 is held in the imaging position P by the manipulator. The container 46 has a vertical orientation.

On one side of the imaging position P, more specifically, on a rear side, the backlight 42, which is flat and plate shaped, is provided as a light source. The backlight 42 irradiates light parallel to a horizontal direction. In the present embodiment, the backlight 42 has a plurality of white LEDs 42a and a plurality of ultraviolet LEDs 42b. That is, as a light for imaging, the white light and the ultraviolet light may be selected. The white light is visible light, and may also be called a normal light. The ultraviolet light is light including a large portion of ultraviolet rays. The normal light is used during the measurement of the hemolysis level and the chyle level, and both the normal light and the ultraviolet light are used during a fibrin measurement. As the light source, a white light source and an ultraviolet light source which are separate entities may be employed, but in the present embodiment, the white light source and the ultraviolet light source are integrated, and thus, a size of the device structure can be reduced. In addition, the camera 44 and the light sources can be easily placed in locations where the camera 44 and the light sources oppose each other.

Alternatively, a diffusion lens or a scatterer may be provided at a front surface side of the backlight 42. Alternatively, a slit or a shutter may be provided at the front surface side of the backlight 42. In FIG. 2, a first horizontal direction is an x direction, a second horizontal direction is a y direction (not shown), and a vertical direction is a z direction.

On the other side of the imaging position P, more specifically, on a front side, the camera 44 which is an imaging device is placed. The camera 44 is, for example, a CCD color camera. In FIG. 1, the entirety of the container 46 is situated within a field of view of the camera 44, but alternatively, it may be the case that only a part of the container 46 is situated within the field of view of the camera 44. For example, a lower end portion of the container 46 may be situated within the field of view of the camera 44. When such a structure is employed, the camera 44 can be moved close to the container 46, and the sample 54 can be observed with a high resolution. In this case, a close-up lens or the like may be used. Alternatively, configurations may be employed in which a plurality of containers are simultaneously imaged, in which the container is imaged while the container is moved, and in which a plurality of backlights and a plurality of cameras are used.

The calculating and controlling unit 38 may be formed from a processor (for example, a CPU) executing a program. In FIG. 2, a plurality of functions realized by the processor are shown by a plurality of blocks. Image data which are output from the camera 44 are sent to a light source evaluator 56 and a property identifier 62. In the present embodiment, a brightness of the white light source is switched as necessary, and a brightness of the ultraviolet light source is not switched. Alternatively, the brightnesses of both the white light source and the ultraviolet light source may be switched.

The light source evaluator 56 determines necessity of a second imaging under a second light source brightness, based on a first image acquired by a first imaging under a first light source brightness. The determination corresponds to determination of appropriateness the first light source brightness or determination of appropriateness of a sample image in the first image. More specifically, the light source evaluator 56 determines, for example, whether or not the first light source brightness is too low, based on a brightness (for example, an average brightness) of the sample image included in the first image. When a color depth of the sample is high, an amount of transmission of light from the backlight becomes small, and the sample image is darkened. In this case, it becomes difficult to correctly evaluate the color of the sample image, or the precision of the color identification is reduced. Thus, in the present embodiment, when it is judged that re-imaging is necessary in a situation where a low brightness is set as the first light source brightness, the second imaging is executed after a high brightness is set as the second light source brightness.

Alternatively, a high brightness may be set as the first light source brightness from the beginning. In this case, when the color depth of the sample is low and the brightness of the sample image in the first image is thus saturated, the color of the sample image cannot be correctly identified. In this case, a low brightness is set as the second light source brightness, and the second imaging is executed. Alternatively, a configuration may be employed in which the first light source brightness can be selected by the user or automatically.

When the light source evaluator 56 judges that the first light source brightness is appropriate, the property identifier 62 identifies the property of the sample based on the first image acquired in the first imaging. On the other hand, when the light source evaluator 56 judges that the first light source brightness is inappropriate, a controller 57 changes the brightness serving as a backlight operation condition, and the second imaging is then executed. The light source evaluator 56 also has an inspection function to check an operation of the backlight 42 (and the camera 44) at the time of startup of the device or the like. This function will be described later.

The calculating and controlling unit 38 has the controller 57. The controller 57 is formed from an imaging controller 58 which controls an operation of the camera 44 and a brightness controller 60 which controls the brightness of the backlight 42. The brightness controller 60 sets, for example, the brightness of the backlight 42 to a low brightness during the first imaging, and to a high brightness during the second imaging. The high brightness is a brightness higher than the low brightness. The imaging controller 58 controls the first imaging and the second imaging by the camera 44. Alternatively, a shutter speed during the first imaging and a shutter speed during the second imaging may be switched. The shutter speed may alternatively be considered to be exposure time.

The property identifier 62 identifies the property of the sample based on the sample image included in the first image when only the first imaging is executed, or based on a sample image included in the second image when both the first imaging and the second imaging are executed. In the following description, an image to be processed by the property identifier 62; that is, an input image of the property identifier 62, will also be called a target image.

A memory 64 is formed from a semiconductor memory or the like, and stores a plurality of determination tables corresponding to a plurality of container types in the present embodiment. When the type of the container is specified by some method, a determination table corresponding to the container type is selected. The property identifier 62 extracts color information (more specifically, a combination of an L* value, an a* value, and a b* value) from the sample image included in the target image, and matches the color information with respect to the selected determination table, to determine the hemolysis level and the chyle level. A determination result thereof is sent through an upper-level system to a transport controller 66 of the sample transport device. Specifically, samples having the hemolysis level of a certain level or higher or the chyle level of a certain level or higher are determined as abnormal samples. The abnormal samples are not sent to the automatic analysis section or the manual analysis section, and instead are sent to the abnormal sample retrieval unit. As shown by reference numeral 68, the information showing the determined hemolysis level and the determined chyle level may be transferred to another device or may be displayed.

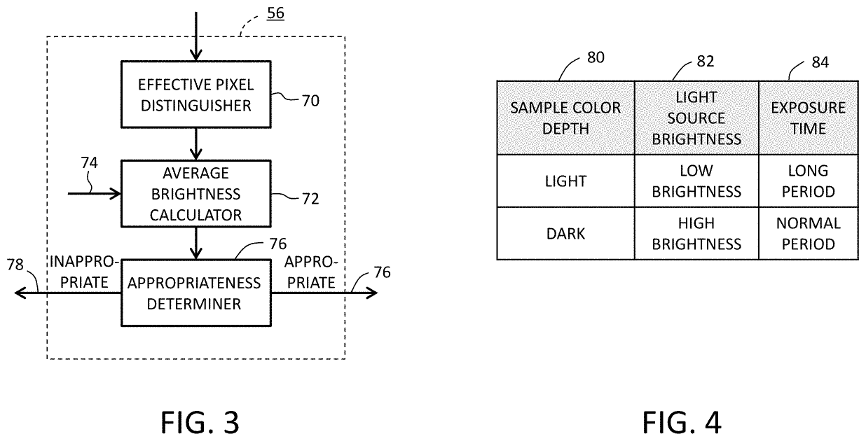

FIG. 3 shows an example structure of the light source evaluator 56. The light source evaluator 56 has a function to evaluate the appropriateness of the light source brightness during the sample imaging. A plurality of blocks shown in FIG. 3 are structures related to this function. The light source evaluator 56 also has an inspection function, but structures related thereto are not shown in FIG. 3.

An effective pixel distinguisher 70 distinguishes a plurality of effective pixels (that is, a group of effective pixels) included in the first image. The effective pixels are pixels included in the sample image, other than ineffective pixels. Pixels corresponding to a container wall surface, pixels outside of the container and corresponding to the light source, pixels in the container and corresponding to mold deficiency locations or ribs, and pixels corresponding to a liquid surface are handled as ineffective pixels.

In the sample image, pixels suited for evaluation of the brightness and the color phase are the effective pixels. An average brightness calculator 72 calculates an average brightness by averaging a plurality of brightnesses of a plurality of effective pixels. The average brightness can also be referred to as a representative brightness representing the sample image. Alternatively, the representative brightness may be calculated by other statistical processes.

The average brightness of the sample image is used as a measure for evaluating whether or not the first light source brightness is appropriate, in relation to the color depth of the sample. An appropriateness determiner 76 determines the appropriateness of the light source brightness during the first imaging; that is, the first light source brightness, based on whether the average brightness is less than a reference brightness or higher than or equal to the reference brightness. When the first light source brightness is inappropriate, as shown by reference numeral 78, the light source brightness is changed, and the second imaging is instructed. When the first light source brightness is appropriate, as shown by reference numeral 76, identification of the sample property based on the first image is instructed.

FIG. 4 shows a relationship between a color depth 80 of the sample and a light source brightness 82. When the sample color depth 80 is low; that is, when the sample color is light, a low brightness is desirable as the light source brightness 82, in order to prevent saturation of the sample image. On the other hand, when the sample color depth 80 is high; that is, when the sample color is dark, a high brightness is desirable as the light source brightness 82, in order to increase the amount of transmission of light for the sample image. The sample color depth 80 may also be referred to as gradation or brightness.

In the present embodiment, the low brightness is set as the light source brightness during the first imaging, and, when it is judged that the setting is not appropriate in relation to the sample color depth, the light source brightness is switched to the high brightness and the second imaging is executed. Alternatively, as already described, the high brightness may be set as the light source brightness during the first imaging, and, when it is judged that the setting is not appropriate in relation to the sample color depth, the light source brightness may be switched to the low brightness and the second imaging may be executed. Alternatively, other configurations may be employed such as, for example, a configuration in which an intermediate brightness is set for the first imaging, the light source brightness is switched, and the second imaging is executed, or a configuration in which the light source brightness is switched among three or more levels.

Alternatively, an exposure time 84 may be switched along with the light source brightness. For example, when the sample color depth 80 is low, a normal time may be set as the exposure time, and, when the sample color depth 80 is high, a time period longer than the normal time may be set as the exposure time. Alternatively, other imaging parameters may be switched.

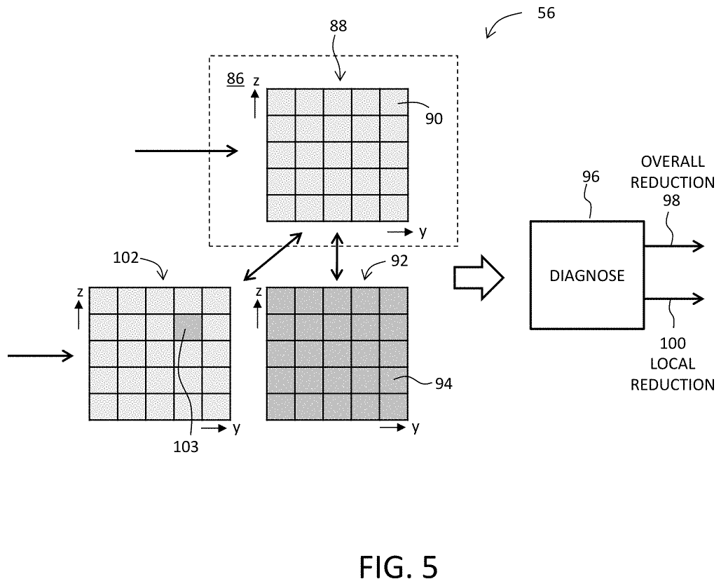

FIG. 5 schematically shows the inspection function of the light source evaluator 56. When reference brightness information for calibration is acquired, a predetermined brightness is set as the light source brightness in a state where no container is placed at the imaging position, and a backlight which is operated to be lighted is imaged. With this process, a reference brightness table 88 formed from a plurality of reference brightnesses 90 is acquired. The reference brightness table 88 is stored in a memory 86. For example, a light source surface is divided into m sections in the y direction and is divided into n sections in the z direction, and (m×n) reference brightnesses corresponding to (m×n) divisions defined thereby are calculated. Each reference brightness is, for example, an average brightness in each area. Alternatively, a single reference brightness may be calculated from the backlight as a whole.

For example, a light source inspection is executed at the time of startup of the sample property identification device, upon completion of the operation of the sample property identification device, or when instructed by the user. In the inspection, a predetermined brightness is set without placing a container at the imaging position, and the backlight operated to be lighted is imaged. Based on an image acquired by this process, (m×n) actually measured brightnesses 94 are calculated for (m×n) divisions. The actually measured brightnesses 94 form an actually measured brightness table 92. Each actually measured brightness 94 is an average value of the brightness in the corresponding division.

As shown by reference numeral 96, the actually measured brightness table 92 and the reference brightness table 88 are compared to each other division by division, to inspect and diagnose degradation and abnormality of the backlight. For example, when a uniform brightness reduction is observed over the plurality of divisions as a whole, an overall reduction 98 is judged. For example, in an actually measured brightness table 102, brightness reduction occurs only in a particular division 103, and, in this case, a local reduction 100 is judged.

The overall reduction 98 in general means degradation of the backlight, and compensation control for increasing the brightness of the backlight is executed in this case. The local reduction 100 in general means a failure of the backlight, a partial uncleanness of the lens of the camera, or the like, and in this case, an error is notified to the user for promoting maintenance. By guaranteeing soundness of the operation of the backlight, the light source brightness can be appropriately switched according to the form of the sample, and, as a consequence, reliability of the property identification result can be improved.

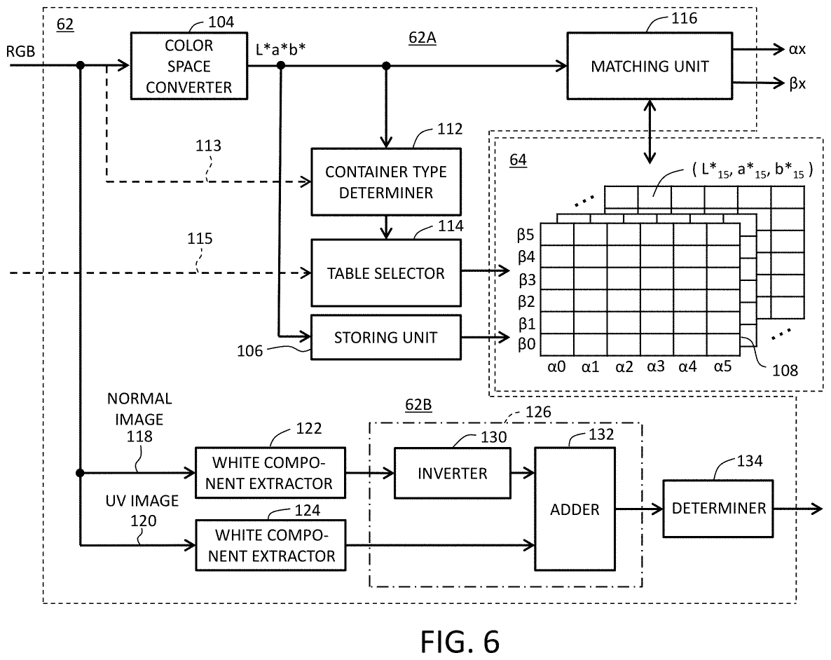

FIG. 6 shows a structure of the property identifier 62 shown in FIG. 2. The illustrated structure is merely exemplary. The property identifier 62 has a hemolysis/chyle identifier 62A and a fibrin identifier 62B.

First, the hemolysis/chyle identifier 62A will be described. A color space converter 104 converts RGB data which is input to L*a*b* data. With this conversion, it becomes easier to handle brightness information and color phase information. The memory 64 stores a plurality of determination tables 108 corresponding to a plurality of container types. For each container type, a plurality of standard samples having different combinations of the hemolysis level and the chyle level are prepared, and are imaged, and a color space conversion or the like is applied to each image, to generate the determination table 108. A storing unit 106 stores the plurality of determination tables 108 in the memory 64.

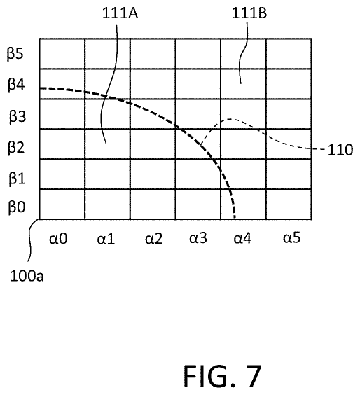

In the illustrated example structure, each determination table 108 is a two-dimensional table made of 6×6 elements. A horizontal axis corresponds to 6 levels of hemolysis (α0˜α5), and a vertical axis corresponds to 6 levels of chyle (β0˜β5). The actual entity of each element is L*a*b* data acquired by imaging the standard sample. Actually, the actual entity is L*a*b* data averaged in the sample image. In FIG. 6, for a certain container type, data forming an element corresponding to a hemolysis level of al and a chyle level of β5 (L*₁₅, a*₁₅, b*₁₅) are shown. In the imaging of the standard sample also, similar to the imaging of the sample which is the target of the property identification, the light source brightness is switched. As the color depth or the light transmittance of each standard sample is known, when the standard sample is imaged, an appropriate brightness can be designated as the light source brightness from the beginning. The switching of the light source brightness based on the color depth or the light transmittance of the sample will be described later with reference to FIG. 7 and with reference to a specific example configuration thereof.

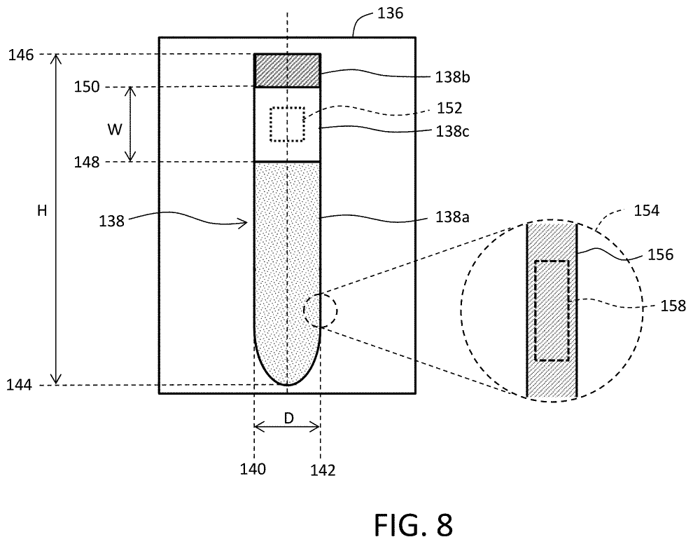

A container type determiner 112 determines the container type based on the L*a*b* data of the target image. For example, the container type may be determined by specifying a color, a diameter (an outer diameter or an inner diameter), or the like of the container. This process will be described later with reference to FIG. 8.

Alternatively, as shown by reference numeral 113, the container type may be determined based on RGB data of the target image. Alternatively, as shown by reference numeral 115, data showing the container type may be supplied from outside. A table selector 114 selects a determination table corresponding to the container type from the plurality of determination tables 108. The selected determination table is referred to in a matching unit 116.

The matching unit 116 checks the L*a*b* data of the sample image in the target image with 36 elements of the selected determination table, and specifies an element which is most similar, to thereby determine a hemolysis level ax and a chyle level 13x for the sample which is the imaging target. Alternatively, a correlation value, a vector norm, or the like may be calculated between the L*a*b* data of the sample image and the L*a*b* data of each element, and a most similar element may be specified based thereon. When a number of determination tables is small, an interpolated table may be generated based on and between two adjacent determination tables, and the generated interpolated table may be added as a matching candidate.

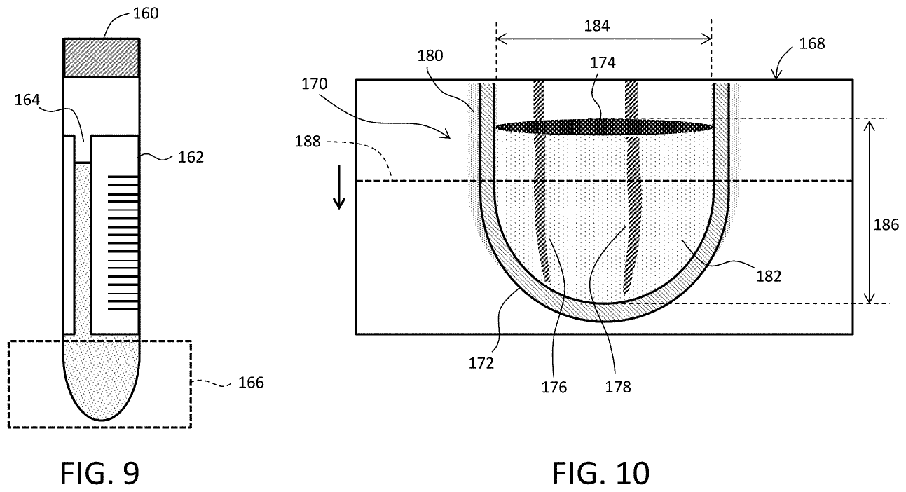

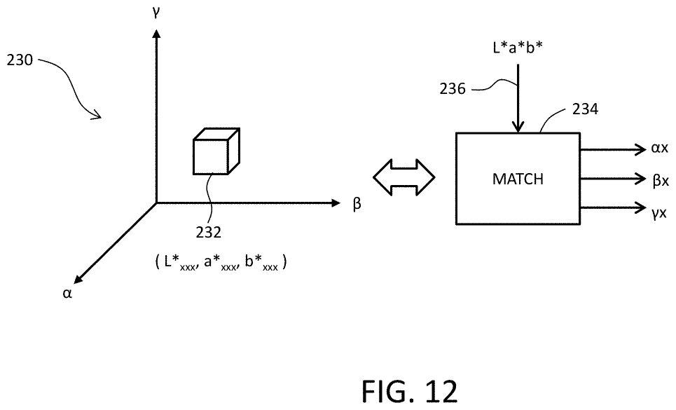

In the present embodiment, the L*a*b* data of the sample image are generated by averaging, for each color space, a plurality of L*a*b* data acquired from a plurality of effective pixels in the sample image. A method of choosing the plurality of effective pixels will be described later with reference to FIGS. 9 to 11. Alternatively, the hemolysis/chyle identifier 62A may further identify presence or absence, or an amount of bilirubin. This process will be described later with reference to FIG. 12.

Next, the fibrin identifier 62B will be described. In the fibrin identification, a normal image 118 and an ultraviolet image (UV image) 120 are sequentially or simultaneously acquired. The normal image 118 is an image acquired using the normal light source, and is the first image or the second image described above. The UV image 120 is an image acquired using the ultraviolet light source. A white component extractor 122 extracts a white component included in the normal image. A white component extractor 124 extracts a white component included in the UV image. A differential image calculator 126 includes an inverter 130 and an adder 132. The inverter 130 inverts an output image of the white component extractor 122, to generate an inverted image. The adder 132 adds the output image of the white component extractor 124 and the inverted image, to generate a fibrin image in which the fibrin is emphasized or extracted.

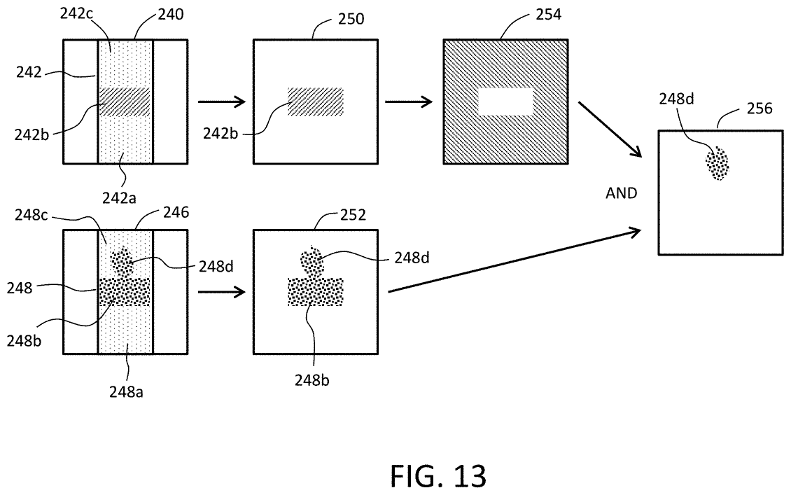

A determiner 134 determines presence or absence, or an existence ratio of the fibrin based on the fibrin image. For example, when the fibrin is included in the sample in a certain amount or more, the sample is determined as an abnormal sample. An image processing in the fibrin identifier 62B will be described later with reference to FIG. 13. In FIG. 6, RGB data are input to the white component extractors 122 and 124, but alternatively, the L*a*b* data after the color space conversion may be input to the white component extractors 122 and 124.

FIG. 7 shows a relationship between the sample property and the light source brightness. A horizontal axis corresponds to 6 levels of hemolysis, and a vertical axis corresponds to 6 levels of chyle. A boundary 110 having an arc shape viewed from an origin 100a is a line separating a low-brightness region 111A and a high-brightness region 111B. When the color depth of the sample is low and the property of the sample belongs to the low-brightness region 111A, a light source brightness appropriate for imaging the sample is a low brightness. On the other hand, when the color depth of the sample is high and the property of the sample belongs to the high-brightness region 111B, a light source brightness appropriate for imaging the sample is a high brightness.

When the light source brightness during the first imaging is not the appropriate brightness, the light source brightness is switched to the appropriate brightness, the second imaging is executed, and the second image acquired thereby is set as the target image. On the other hand, when the light source brightness during the first imaging is the appropriate brightness, the first image acquired in the first imaging is set as the target image. Alternatively, the light source brightness may be switched between three or more levels. In this case, three or more brightness regions are defined by two or more arcs having a common origin.

FIG. 8 exemplifies a method of determining the container type. An image 136 is the first image or the second image. The image 136 includes a container image 138. The container image 138 is formed from a sample image 138a, a plug image 138b, and an air layer image 138c. For example, ends 140 and 142 in the horizontal direction of the container image 138 may be specified, and a width D of the container image 138 may be specified based on the ends 140 and 142. The width D corresponds to an outer diameter of the container. Alternatively, a lower end 144 and an upper end 146 of the container image may be specified, and a height H of the container image 138 may be specified based on the lower and upper ends 144 and 146. Alternatively, the container type may be determined based on the width D and the height H.

Alternatively, a lower end 148 and an upper end 150 of the air layer image 138c may be specified, a region of interest 152 may be set in the air layer image 138c, and reference may be made to color data (color phase, brightness, or the like) in the region of interest 152. Alternatively, as shown in an enlarged partial view 154, a region of interest 158 may be set inside a wall image 156, and reference may be made to color data (color phase, brightness, or the like) in the region of interest 158. The container type may be determined based on the color data.

FIG. 9 shows a method of determining effective pixels. In the illustrated example configuration, an imaging area 166 is set at a lower part of a container 160. A label 162 including a barcode is adhered to the container 160. While a gap 164 is created between the ends, in order to specify an orientation of the gap 164 and direct the orientation toward the camera side, a structure and control for this process is necessary. Thus, in order to enable observation of the sample at all times, the lower part of the container 160 is set as the imaging target, and the imaging area 166 as shown in the figure is defined.

FIG. 10 shows an image 168 acquired by imaging of the imaging area. The image 168 is a target image which is input to the property identifier. The image 168 includes a container image 170. The container image 170 includes a wall image 172 and a sample image 182. In the illustrated example structure, the sample image 182 further includes a liquid surface image 174 and streak images 176 and 178. The container image 170 includes a rib image 180 continuous on an outer side of the wall image 172. The sample image 182 exists in a division 184 in the horizontal direction, and in a division 186 in the vertical direction.

In general, in a container molding process, a pressure is applied to the container. Because of this, in many cases, a plurality of streaks are caused on the container. When fine observation is executed, the plurality of streaks appear as a plurality of streak images 176 and 178 in the image. When pixels forming the streak images 176 and 178 are included in the group of effective pixels to be referred to, the property identification precision would be reduced. This is similarly true for the plurality of pixels forming the liquid surface image 174. Therefore, in the present embodiment, these pixels are handled as ineffective pixels, as will be described below in detail. When a plurality of ribs are provided on the container, the rib image 180 occurs. An image processing is desired so that the pixels forming the rib image 180 are not handled as the effective pixels.

In consideration of the above circumstances, in the present embodiment, a reference line 188 is set at each height position, and one or a plurality of effective pixels are extracted and determined from a pixel column forming the reference line 188. A range in the up-and-down direction for search of the effective pixels is the division 186. Ends of the division 186 are specified by methods such as edge detection, image recognition, or the like.

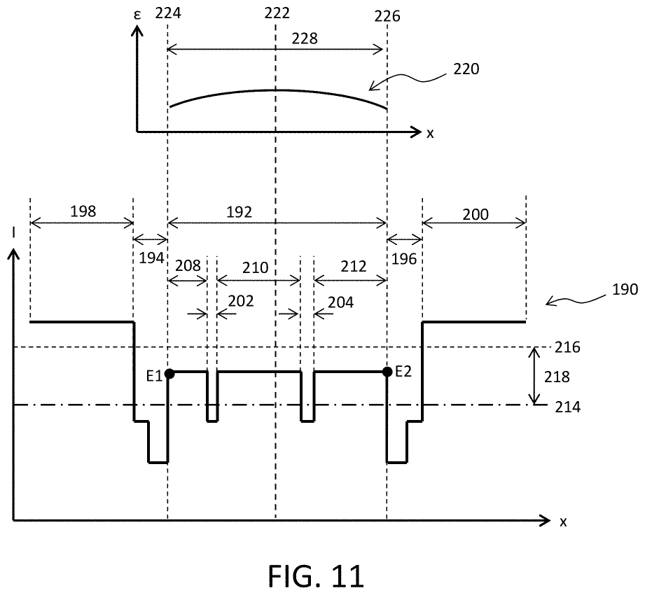

At a lower part of FIG. 11, a brightness distribution 190 on the reference line is schematically shown for ease of understanding. The brightness distribution 190 is for the purpose of explanation, and an actual brightness distribution has a smoothly changing form.

A division 192 corresponds to an inside of the container, and a division 194 and a division 196 correspond to the wall surface and the rib. A division 198 and a division 200 correspond to an outside of the container. In the illustrated example configuration, a threshold 214 is set with respect to the brightness distribution 190. In addition, another threshold 216 is set at a level higher than the threshold 214. The threshold 214 is a threshold for distinguishing between the effective pixel and the ineffective pixel, and the threshold 216 is a threshold for distinguishing between the inside and the outside of the container. For example, in a division 218 between the threshold 214 and the threshold 216, two edges E1 and E2 at an outermost side on both side in the horizontal direction are specified. From these edges, a width of the sample image; that is, the division 192, can be specified.

For example, in the division 192, pixels having a brightness greater than or equal to the threshold 214 are set as the effective pixels. A division 202 and a division 204 both correspond to streak images, and pixels belonging thereto are set as the ineffective pixels. Thus, pixels belonging to divisions 208, 210, and 212 are set as the effective pixels.

As described, in the present embodiment, a range where the sample image exists is specified, and the effective pixels are searched within this range, using the thresholds. As a result of this process, pixels corresponding to the wall image, the rib image, the streak image, the liquid surface image, and the like, are invalidated. By referring to a larger number of effective pixels while removing the ineffective pixels, the property identification precision can be improved. The content of FIG. 11 is merely exemplary, and methods other than the method described above may be employed as the method of extracting the effective pixels.

FIG. 11 shows at an upper part a correction function 220. A width 228 of the correction function 220 corresponds to the division 192 where the sample image exists. The correction function 220 has a curved form corresponding to a change of a radius of curvature of the container. A center of the container is shown with reference numeral 222.

A correction coefficient c specified by the correction function 220 may be applied to brightness or color data determined at each coordinate in the horizontal direction, to compensate for a brightness change or a color change which depends on the radius of curvature of the container. So long as such a compensation is applied during generation of the determination tables, the compensation for the sample image would be sufficient.

FIG. 12 exemplifies a method of simultaneously identifying the hemolysis level, the chyle level, and the bilirubin amount. In a three-dimensional determination matrix 230, three axes correspond to the hemolysis level α, the chyle level β, and the bilirubin amount γ. The three-dimensional determination matrix 230 is formed from a plurality of elements 232, with each element 232 corresponding to a particular combination of the hemolysis level, the chyle level, and the bilirubin amount. As shown by reference numeral 234, color data 236 of the sample image may be checked with the plurality of elements 232 of the three-dimensional determination matrix 230, to specify a most similar element, so that the hemolysis level αx, the chyle level βx, and the bilirubin amount γx can be simultaneously identified for the sample being imaged.

FIG. 13 shows an image processing at the fibrin identifier shown in FIG. 6. A normal image 240 includes a container image 242. In the illustrated example configuration, the container image 242 includes a blood clot image 242a, a separating agent image 242b, and a blood serum image 242c. On the other hand, an UV image 246 includes a container image 248, and, in the illustrated example configuration, the container image 248 includes a blood clot image 248a, a separating agent image 248b, a blood serum image 248c, and a fibrin image 248d. It is known that, when ultraviolet light is irradiated onto the fibrin and the separating agent, the fibrin and the separating agent glow. The method of identifying fibrin in the present embodiment takes advantage of this phenomenon.

An image 250 is generated by extracting a white component (high-brightness component) from the normal image 240. The image 250 includes the separating agent image 242b serving as the white component. Meanwhile, an image 252 is generated by extracting a white component (high-brightness component) from the UV image 246. The image 252 includes the separating agent image 248b and the fibrin image 248d serving as the white component. In the generation of the image 250 and the image 252, a binarization process may be applied. An inverted image 254 is generated by applying an inversion process to the image 250.

An image 256 is generated by adding the image 252 and the inverted image 254. The two separating agent images are cancelled out by this addition, and the fibrin image 248d alone is extracted. The presence or absence, or an amount of fibrin is specified based on this image 256.

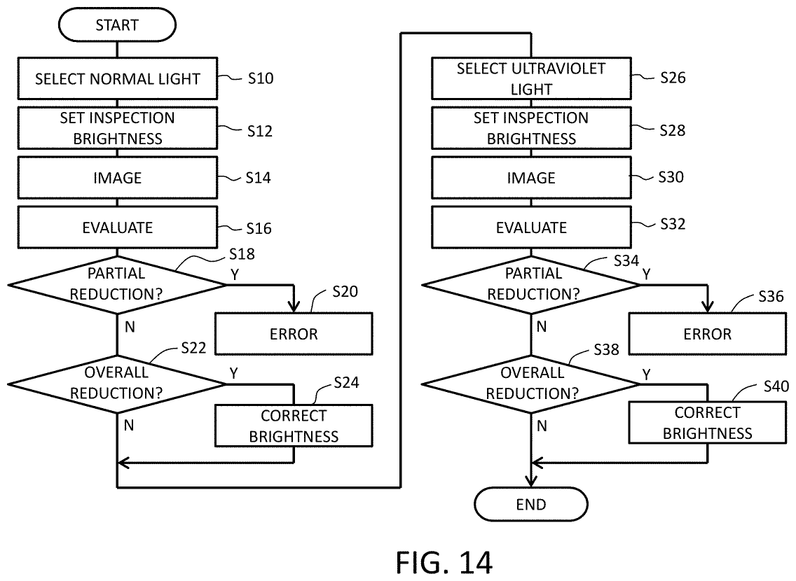

FIG. 14 shows as a flowchart an inspection method which is executed prior to the method of identifying the sample property. The contents of FIG. 14 show control contents of a controller.

In S10, the normal light is selected as the light of the backlight. In S12, an inspection brightness is set as the brightness of the backlight. In S14, in a state where no container is positioned at the imaging position, the backlight which is operated to be lighted is imaged by the camera. In S16, an image acquired by the imaging is evaluated. Specifically, one of appropriate brightness, partial reduction, or overall reduction is determined.

When the partial reduction is determined in S16, the process proceeds through S18 and an error process is executed in S20. For example, information promoting maintenance is provided to the user. In this case, information for specifying the division where the partial reduction occurs may be provided to the user. When the overall reduction is determined in S16, the process proceeds through S18 and S22, and the brightness of the backlight is corrected in S24. When the brightness reduction is caused by degradation of the backlight, the brightness of the backlight is increased, to compensate for the brightness. The imaging and evaluation may be repeated until an appropriate brightness is reached. When the appropriate brightness is determined in S16, the process proceeds through S18 and S22, and S26 is executed.

In S26, the ultraviolet light is selected as the light of the backlight. In S28, the inspection brightness is set. Then, in a state where no container is positioned at the imaging position, the backlight which is operated to be lighted is imaged by the camera. In S32, a captured image is evaluated, similar to S16.

More specifically, when the partial reduction is determined in S32, the process proceeds through S34, and an error process is executed in S36. When the overall reduction is determined in S32, the process proceeds through S34 and S38, and the brightness of the backlight is corrected in S40. When the appropriate brightness is determined in S32, the process proceeds through S34 and S38, and the present process is completed.

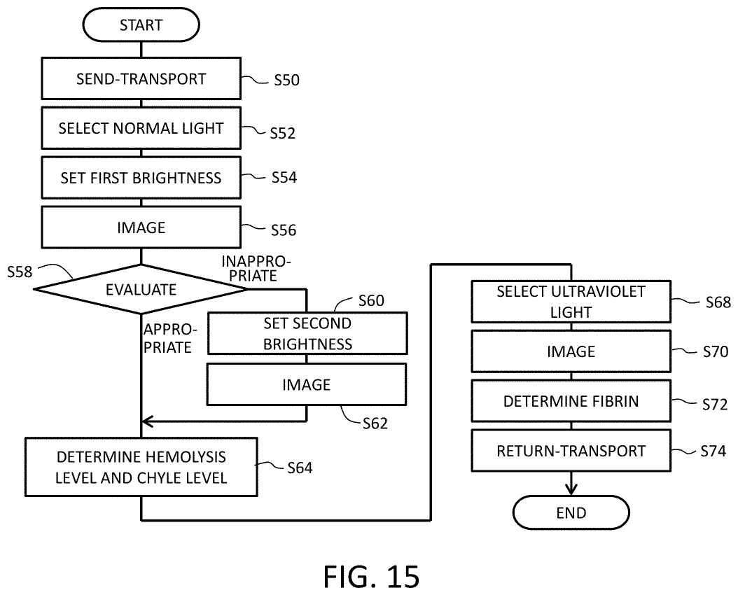

FIG. 15 shows as a flowchart a method of identifying a sample property according to the present embodiment. The contents of FIG. 15 show control contents of a controller. The process shown in FIG. 15 is executed for each sample.

In S50, the container is transported by the manipulator from the rack to the imaging position. In S52, the normal light is selected as the light of the backlight, and in S54, a first brightness is set as the brightness of the backlight. The first brightness is, for example, a low brightness. Alternatively, S52 and S54 may be executed before S50. In S56, in a lighted state of the backlight, the container is imaged by the camera. With this process, the first image is acquired. If an imaging of a second time is to be executed, the first imaging is a provisional imaging and the second imaging is a main imaging.

In S58, a captured image is evaluated, and the image is determined to be appropriate or inappropriate. When the image is determined as inappropriate in S58, a second brightness is set as the brightness of the backlight in S60, and the container is again imaged by the camera in S62. For example, when the brightness of the sample image is lower than a certain value, the image is determined as inappropriate, and when the brightness of the sample image is greater than or equal to the certain value, the image is determined to be appropriate. The second brightness is, for example, a high brightness higher than the low brightness. The imaging at S62 is the second imaging, and an image acquired thereby is the second image.

In S64, based on the color and the color depth of the sample image in the target image, the hemolysis level is determined and the chyle level is determined. The target image is the first image when the second imaging is not executed or the second image when the second imaging is executed. In the determinations of the hemolysis level and the chyle level, reference is made to the determination table corresponding to the type of the container which is the imaging target. Alternatively, the hemolysis level and the chyle level may be determined by other methods. For example, the sample image may be evaluated in a color space other than L*a*b*.

Next, in S68, the ultraviolet light is selected as the light of the backlight, and in S70, the container is imaged in a state where the ultraviolet light is irradiated. With this process, the UV image is acquired. In S72, for example, the presence or absence, or an amount of fibrin is determined based on the above-described target image (normal image) and the UV image. In S74, the container which has already been imaged is transported by the manipulator from the imaging position to the rack.

According to the method of identifying the sample property described above, the property of the sample can be identified based on an image captured under a light source brightness suited for the color depth of the sample, and thus, the reliability of the identification result can be improved.

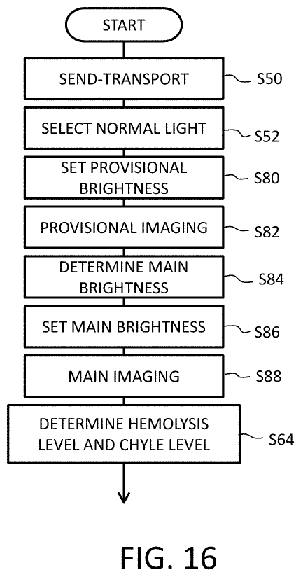

FIG. 16 shows as a flowchart an alternative configuration of a method of identifying the sample property according to the embodiment. Steps similar to the steps of FIG. 15 are assigned the same reference numerals, and will not be repeatedly described.

In S80, a provisional brightness is set as the brightness of the backlight. The provisional brightness is, for example, an intermediate brightness between the above-described low brightness and the above-described high brightness. In S82, the container is imaged in a lighted state of the backlight. This imaging is the first imaging, and is also a provisional imaging. An image acquired in this imaging is a provisional image. In S84, a main brightness is determined as the light source brightness in the second imaging based on the provisional image; more specifically, the size of the brightness of the sample image in the provisional image. The main brightness is, for example, a low brightness or a high brightness. In S86, the main brightness is actually set as the brightness of the backlight.

In S88, the main imaging is executed as the second imaging, and a main image is acquired by the second imaging. In S64, the hemolysis level and the chyle level are determined based on the main image. After S64, processes from S68 and on shown in FIG. 15 are executed. In this manner, a configuration may be employed in which the light source brightness during the first imaging is set assuming that the second imaging will be executed.

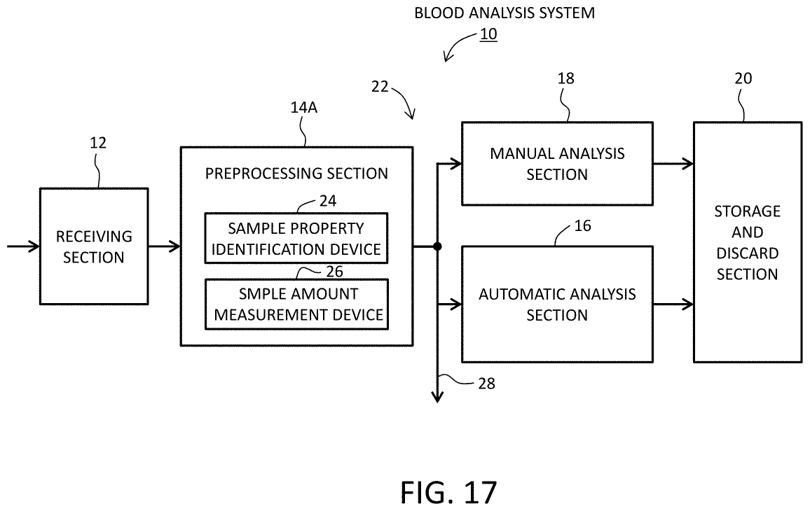

FIG. 17 shows a blood analysis system including a second example of the preprocessing section. In the following description, elements similar to those shown in FIG. 2 are assigned the same reference numerals, and will not be repeatedly described. A preprocessing section 14A shown in FIG. 17 has, in addition to the sample property identification device 24, a sample amount measurement device 26. The sample amount measurement device 26 is a device which measures an amount of the sample. Here, the sample is, for example, a sample for which no problem occurs even when an orientation of the container is changed or a sample for which change of the orientation of the container before analysis is desired. For example, the sample is whole blood or urine.

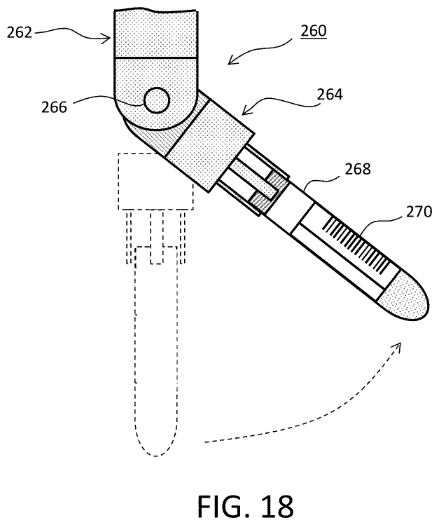

FIG. 18 shows a manipulator 260 of the sample amount measurement device. The manipulator 260 is a mechanism which holds and transports a container 268. More specifically, the manipulator 260 has an arm 262 and a clamp unit 264, and a rotation mechanism is provided between the arm 262 and the clamp unit 264. FIG. 18 shows a rotational axis 266 of the rotation mechanism.

A label 270 having a barcode is adhered to the container. The label 270 is provided over an entire circumference of the container 268, and liquid surface cannot be observed from a gap. In the container 268 having a vertical orientation, when the liquid surface is hidden by the label 270 or, even though there is a gap, observation of the liquid surface through the gap is not possible, measurement of the liquid amount based on the image is not possible. Thus, the orientation of the container is changed, the container is imaged, and the liquid surface level; that is, the liquid amount, is analyzed by analyzing the image. Specifically, an angle of the clamp unit 264 is changed by the manipulator 260 so that the container is in a horizontal orientation.

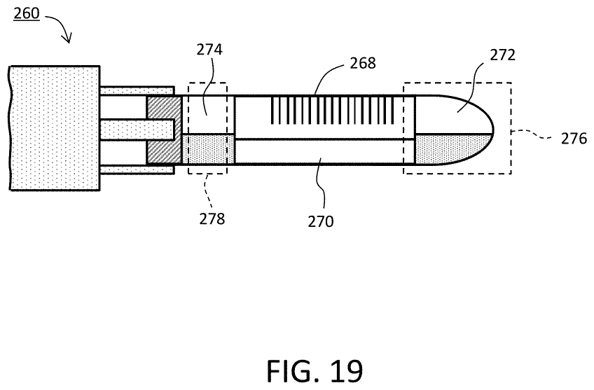

FIG. 19 shows the container 268 having the horizontal orientation. An intermediate portion of the container 268 is completely covered by the label 270, but the liquid surface appears at a tip 272 and a base end 274 of the container 268. An imaging area 276 is set for the tip 272 or an imaging area 278 is set for the base end 274. One of the imaging areas 276 and 278 is imaged. Alternatively, both imaging areas 276 and 278 may be imaged.

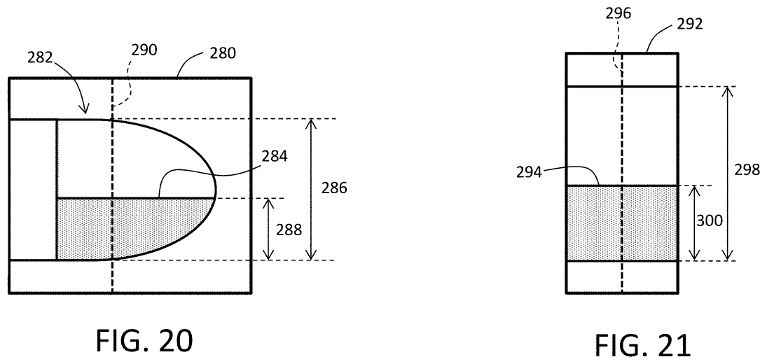

FIG. 20 shows an image 280 acquired by imaging the tip. A container image 282 includes a horizontal liquid surface image 284. For example, a vertical measurement line 290 is set, and liquid surface is detected within a range 286 corresponding to the inside of the container, to specify a level 288 where the liquid surface image 284 exists. Based on this level, the amount of sample can be calculated. Alternatively, a plurality of the measurement lines may be set, and the level of the liquid surface image may be specified at a plurality of locations.

FIG. 21 shows an image 292 acquired by imaging the base end. The image 292 includes a liquid surface image 294. Similar to the above, the liquid surface is detected on a measurement line 296 in a range 298 corresponding to the inside of the container, to specify a level 300 of the liquid surface image 294. For the liquid surface detection, known methods may be employed such as a threshold detection method, an edge detection method, or the like. Alternatively, the liquid surface level may be specified at both the tip and the base end, to confirm the horizontal state of the container, and the amount of sample may then be calculated. Alternatively, the amount of sample may be calculated based on two liquid surface levels specified at both the tip and the base end.

### (3) Other Characteristics in the Embodiment

The above description of the embodiment includes a sample characteristic identification device having means that irradiates a blood sample with ultraviolet light, means that images the blood sample to acquire a sample image in a state of irradiation with the ultraviolet light, and means that generates fibrin information based on the sample image. That is, the embodiment includes a fibrin specifying technique using the ultraviolet light. In a sample which does not include the separating agent, the above-described differential process is not necessary, and, in this case, the fibrin information can be specified from the UV image along serving as the sample image. When this structure is employed, a backlight which irradiates the blood sample with ultraviolet light is provided as necessary. The blood sample may be irradiated with the ultraviolet light from a front side, from a side, or the like. When the blood sample is irradiated from the front side, a background board having a background color which makes the fibrin clearer or which emphasizes the fibrin may be provided on a back surface side of the blood sample. When the blood sample is irradiated from the side also, such a background board may be used.

Further, the above description of the embodiment includes a sample amount calculating device having a handling mechanism that changes an orientation of a sample container from a standing orientation to an inclined orientation, a camera that images the sample container in the inclined orientation to generate a container image, and a calculator which calculates an amount of sample in the sample container based on a liquid surface image in the container image. As the inclined orientation, a horizontal orientation is desirably employed, but alternatively, other inclined orientations may be employed so long as the liquid surface image can be observed. The amount of sample can be calculated based on an inclination angle and the position of the liquid surface image. When this structure is employed, a backlight is provided as necessary.

In addition to the above, the present specification includes various characteristics. Each of these characteristics may be independently employed as a single entity.

1. A sample property identification device comprising:
a light source that is provided at one side of an imaging position at which a container containing a sample is placed;
a camera that is provided at the other side of the imaging position, that images the container to acquire a first image during a first imaging, and that images the container to acquire a second image during a second imaging subsequent to the first imaging;
a controller that sets, prior to the second imaging, an operation condition of the light source in the second imaging, based on a sample image included in the first image; and
an identifier that identifies a property of the sample based on a sample image included in the second image.

2. The sample property identification device according to claim 1, wherein
the controller sets a brightness of the light source in the second imaging, based on a brightness of the sample image included in the first image.

3. The sample property identification device according to claim 2, wherein
the controller:
sets a brightness of the light source in the first image to a first brightness; and
sets a second brightness which is lower than the first brightness as the brightness of the light source in the second imaging when the brightness of the sample image included in the first image is determined to be too high, or sets a second brightness which is higher than the first brightness as the brightness of the light source in the second imaging when the brightness of the sample image included in the first image is determined to be too low.

4. The sample property identification device according to claim 3, wherein
the controller:
sets a low brightness as the brightness of the light source in the second imaging when the brightness of the sample image included in the first image is determined to be too high; and
sets a high brightness which is higher than the low brightness as the brightness of the light source in the second imaging when the brightness of the sample image included in the first image is determined to be too low.

5. The sample property identification device according to claim 1, wherein
the sample is blood serum or blood plasma, and
the identifier identifies a hemolysis level and a chyle level based on the sample image included in the second image.

6. The sample property identification device according to claim 5, wherein
the identifier changes a hemolysis level determination condition and a chyle level determination condition based on a type of the container containing the sample.

7. The sample property identification device according to claim 5, wherein
the identifier specifies a group of effective pixels in the sample image included in the second image, and identifies the property of the sample based on the group of effective pixels.

8. The sample property identification device according to claim 7, wherein
the identifier specifies pixels in the sample image other than one or a plurality of ineffective pixels as the group of effective pixels, and
the one or the plurality of the ineffective pixels include at least one of a pixel corresponding to a rib provided on the container or a pixel corresponding to a streak caused during a molding process of the container.

9. The sample property identification device according to claim 1, wherein
the controller evaluates the light source based on an image acquired by imaging the light source under a situation where no container exists at the imaging position.

10. The sample property identification device according to claim 1, wherein
a normal light source and an ultraviolet light source are provided as the light source, and
the identifier includes an image processor which generates a fibrin image in which fibrin is emphasized, based on an image acquired by imaging the container using the normal light source and an image acquired by imaging the container using the ultraviolet light source.

11. A method of identifying a property of a sample, the method comprising:
executing, in a state where a container containing a sample is placed between a light source and a camera, a first imaging on the container to acquire a first image;
setting a brightness of the light source in a second imaging subsequent to the first imaging, based on a sample image included in the first image;
executing, after the setting of the brightness, the second imaging on the container to acquire a second image; and
identifying a property of the sample based on a sample image included in the second image.

12. A sample transport system comprising:
a transport device that transports a container containing a sample from a receiving section to an analyzing section; and
a sample identification device that is provided between the receiving section and the analyzing section, wherein
the sample identification device comprises:
a light source which is provided at one side of an imaging position at which the container is placed;
a camera which is provided at the other side of the imaging position, which images the container to acquire a first image during a first imaging, and which images the container to acquire a second image during a second imaging subsequent to the first imaging;
a controller which sets, prior to the second imaging, an operation condition of the light source in the second imaging based on a sample image included in the first image; and
an identifier which identifies whether or not the sample is an abnormal sample based on a sample image included in the second image, and
when the sample is the abnormal sample, the transport device does not transport the container containing the sample to the analyzing section, and instead transports the container to an abnormal sample retrieval unit.
